(19) United States
(12) Patent Application Publication
(10) Pub. No.: US 2021/0304635 A1
(43) Pub. Date: Sep. 30, 2021

(54) SYM-Qube

(71) Applicant: Constance Maria Ridley Smith, Nashville, TN (US)

(72) Inventor: Constance Maria Ridley Smith, Nashville, TN (US)

(21) Appl. No.: 16/832,015

(22) Filed: Mar. 27, 2020

(51) Int. Cl. G09B 19/00; G09B 1/32

(52) U.S. Cl. CPC G09B 19/00; G09B 1/32

(57) ABSTRACT

The SYM-Qube is related to the fields of 1) organizational development, 2) intercultural effectiveness, 3) cultural intelligence, and 4) Symbiotic Intelligence, also known as SYM-Q. The SYM-Qube is a prompt, a device, a manipulative, a kinesthetic tool that makes known and reinforces the types of attributes that help symbiotic exchanges to thrive. The SYM-Qube makes tangible the abstract, unknown SYM-Q concepts that are presented for memorization and the interrelationships between the component parts. The SYM-Qube reinforces ideas presented in the book, Beyond Bricks and Mortar: 5 Factors that Predict Intercultural Success, in the SYM-Q training videos, and in written and oral SYM-Q training programs. The SYM-Qube dually encodes the information contained in the SYM-Q method. It does so by presenting a kinesthetic application to reinforce spoken and read (visual) data, capturing the learner in learning modalities he or she can best learn, retain, and use the data.

### PARTS LIST THAT MAKES UP THE INVENTION

One T-Block measuring 2 5/16″×0.75″ and one 1×1″ block, joined at the center of the 2 5/16″ block
One Poly-Block consisting of one 1.5″×0.75″ block and two 0.75″×0.75″ blocks attached to the 1.5″×0.75″ block at perpendicular corners
One L-Block consisting of one 1.5″×0.75″ block and one 0.75″×0.75″ block attached to the 1.5″×0.75″ block at one end
Three single 1.5″×0.75″ blocks
One single 0.75″×0.75″ block

Using the parts named above, the SYM-Qube has three moves or combinations from the same blocks. These three moves are used in the training session. The fourth move encloses the set of blocks into a composite, packed away, storable version, for which the T-Block becomes usable.

The blocks are shown on FIGS. 1-5, with the text that appears on the blocks, described as follows.

### DESCRIPTION OF THE FIGURES

FIG. 1 shows theo SYM-Qube in Move 1, depicting the Factors that Predict Intercultural Success: Individual Factors (IND); Cultural Factors (CUL); Collaborative Factors (COL); and Gen-Tech Factors (GEN-TECH); and the effect that these four factors have on The Exchange (THE EXC) between Newcomers and Members of the Existing Environment.

FIG. 2 shows the SYM-Qube in Move 2, showing the Positive Attributes that are needed to create SYM-Q or Symbiotic Intelligence: Acceptance, Inclusion, Respectfulness, and Support. These are known by the acronym, AIR Support

FIG. 3 shows the SYM-Qube in Move 3, showing the Negative Attributes that prevent SYM-Q or Symbiotic Intelligence: Resentment, Isolation, Dominance, and Stereotypes. These are known by the acronym, RID Stereotypes.

FIG. 4 shows the SYM-Qube in Move 4, showing the SYM-Q in a composite block.

FIG. 5 shows the text that appears on the front and back of the T-Block, the block that forms the closure in the packed away, storable version of the SYM-Qube.

### BACKGROUND OF THE INVENTION

The SYM-Qube is related to the fields of 1) organizational development, 2) intercultural effectiveness, and 3) cultural intelligence, and 4) the next step up from cultural intelligence, known as Symbiotic Intelligence. Symbiotic Intelligence is more commonly known as SYM-Q. Symbiotic Intelligence promotes and makes intentional reciprocal actions between members of an existing environment and newcomers. Foremost, Intelligence recognizes that the quality of the intercultural exchange is wholly dependent upon both parties making the necessary adjustments to create the type of environment in which mutual goals take precedence over individual goals and that these goals must be achieved, symbiotically, hence the name symbiotic intelligence.

The SYM-Qube is a prompt, a device, a manipulative, a kinesthetic tool that makes known and reinforces the types of attributes that help symbiotic exchanges to thrive.

### Influence of Extant Research.

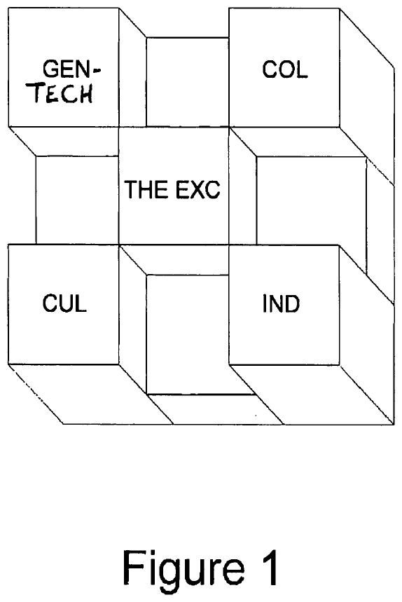

SYM-Qube makes reference to a body of information common to intercultural effectiveness and cultural intelligence research. The common information is contained in the research on cultural intelligence and can be identified as four terms that are used in discussions about intercultural effectiveness and in the research about cultural intelligence and multicultural work settings. The four terms are: 1) environmental or cultural factors, 2) individual attributes, 3) job identity factors and 4) the CQ Exchange. With the exception of the term cultural/cultural factors, which is a term in common use in multiple disciplines, the remaining three aspects first became known to the applicant/inventor during her own doctoral dissertation research, through the work of Gibson and Dibble (n.d.), Ang and VanDyne (2008), Buckley, Gaister, and Husan (2002), and Inkpen and Currall (2004). All of these researchers/authors used one or more of these terms, however, neither of these researchers created a model utilizing the factors, comprehensively (as depicted in FIG. 1), as the applicant/inventor has done; nor did they describe them, as the applicant/inventor has, in her writings, as predictors of intercultural success.

### Influence of the Inventor's Own Research.

In her departure from CQ and enlargement of her own intercultural research, the inventor addressed the literature gap in cultural intelligence based upon her research participants in the educational arena (2003-2015). Her doctoral dissertation research resulted in the idea to pair the extant job identity factors with Academic Considerations such as academic resources, academic rigor, academic support, academic climate, etc. and to regard and rename both sets as the Collaborative Factors. The applicant/inventor added for consideration a fifth factor or predictor of intercultural success, proposing the Generational Factors as a determinant of intercultural success. Regard for the Generational Factors was made necessary by the rapid rise of technology and an atypical hierarchy in the workplace caused by lingering Boomer and tech-savvy Millennials, who often became their managers. The new currency for collaboration was the ability to use technology. The applicant/inventor later renamed the Generational Factors, coining the term, “Gen-Tech” Factors. The applicant/inventor's research begged the need to foreground the need to spell out intentional reciprocal actions between the newcomer and members of the existing cultural environment. They are shown on the outer rings of the SYM-Q Model, which can be found in the book that the applicant wrote on the subject. To assist others in understanding the interrelationship of these factors, the applicant/inventor created a visual depiction of her research outcomes. FIGS. 1-5 show the SYM-Qube, a visual, kinesthetic tool for learning and discussing the SYM-Q Model.

The learner/applicant documented her research in the book, Beyond Bricks and Mortar: 5 Factors that Predict intercultural Success. In the book, the inventor cites and references the contributions of the researchers who preceded her, namely the four factors as described above and journals the enlargement of ideas; a process which led to symbiotic intelligence and the development of the SYM-Qube to explain it and represent it. See FIG. 1.

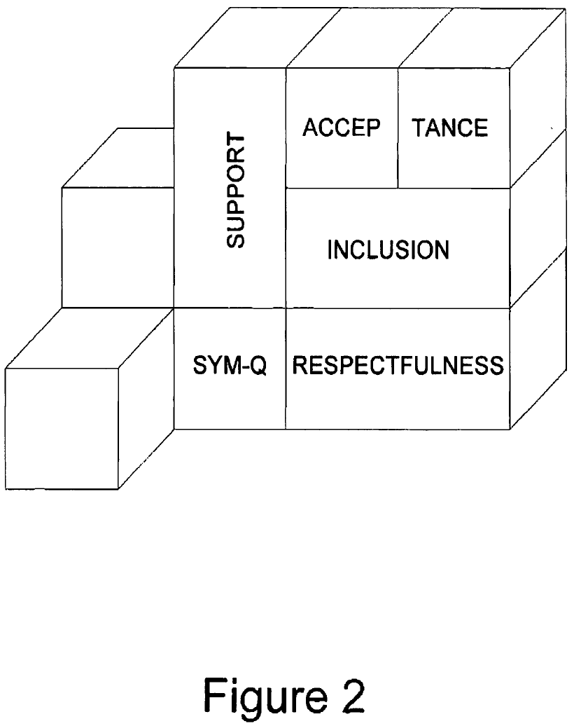

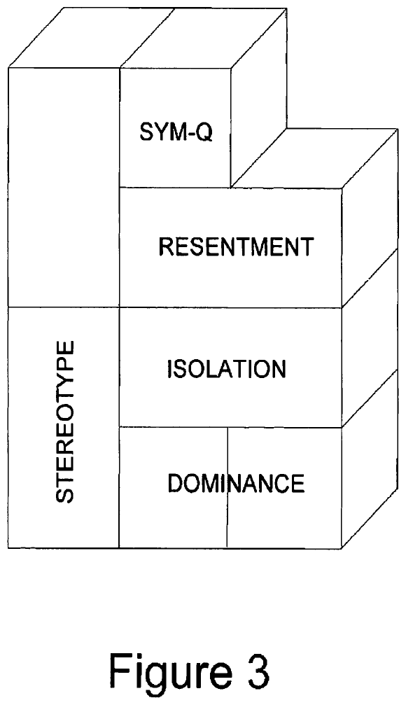

Next, the applicant/inventor created two video lessons to describe the need for Acceptance, Inclusion, and Respectfulness and Support in the set of reciprocal actions (called AIR+Support). FIG. 2 depicts that. FIG. 3 depicts the actions that are associated with negative attributes (Resentment, Isolation, Dominance+Stereotypes) This is completely new information that was developed by the applicant, the inventor of the SYM-Aube. It aligns with the preamble to Chapter Two of the applicant/inventor's book, Beyond Bricks and Mortar: 5 Factors that Predict Intercultural Success.

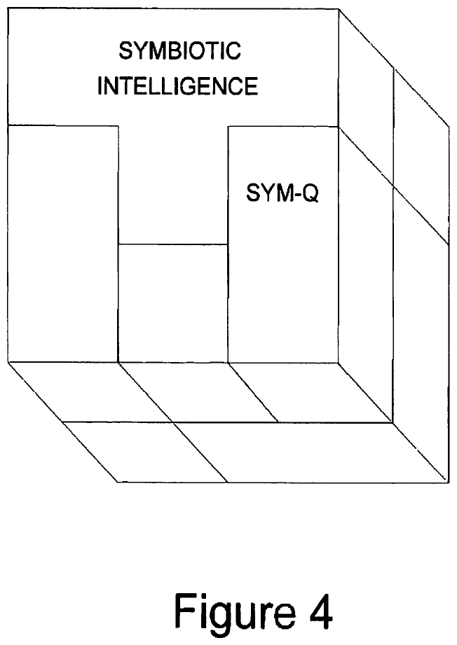

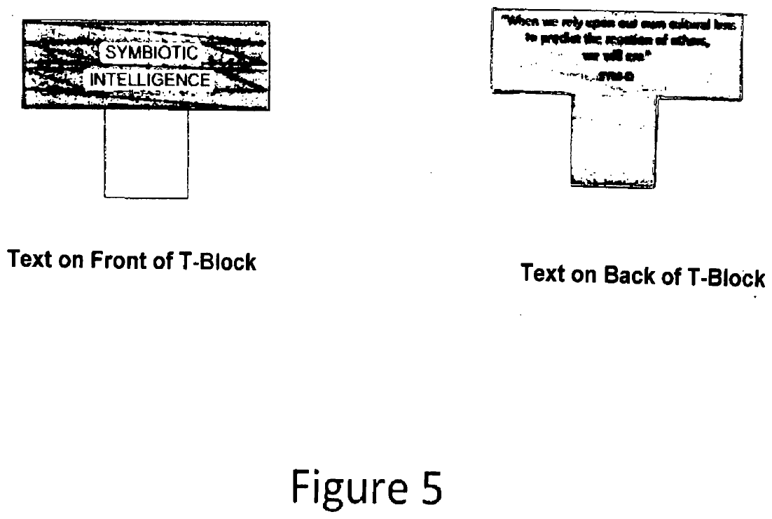

FIG. 4 shows the SYM-Qube in packed away, storage mode, with all parts forming the cube; hence the term, SYM-Qube. FIG. 5 shows the text that appears on the front and back of SYM-Qube's T-Block, used to facilitate packing away and storage.

1. Of course, wooden blocks are not a new invention. The inventor's claim is the way in which the blocks have been arranged and will be used to support training, organizational development, and to convey the ideas contained in those programs.
The invention is the utility for which the blocks are employed; the novel use of the blocks to form Combinations and Sub-Combinations and the transference of the written ideas superimposed on the blocks with each combination.
